(19) United States
(12) Patent Application Publication
(10) Pub. No.: US 2025/0130118 A1
(43) Pub. Date: Apr. 24, 2025

(54) RESISTANCE TEMPERATURE DETECTORS

(71) Applicant: KOREA AEROSPACE RESEARCH INSTITUTE, Daejeon (KR)

(72) Inventors: Juwan KIM, Daejeon (KR); Sangwoon JEON, Daejeon (KR); Gyu Sik CHO, Daejeon (KR); Kon Yi HEO, Sejong-si (KR)

(21) Appl. No.: 18/924,739

(22) Filed: Oct. 23, 2024

(30) Foreign Application Priority Data
Oct. 23, 2023 (KR) 10-2023-0141894

(51) Int. Cl. G01K 7/16

(52) U.S. Cl. CPC G01K 7/16

(57) ABSTRACT

Provided is a resistance temperature detector (RTD), and in particular, to an RTD that minimizes damage from thermal stress. The present disclosure is to solve the problem of electric wire disconnection caused by thermal stress and minimize damage due to a ferrule in a portion in which the ferrule is mounted.

### CROSS-REFERENCE TO RELATED APPLICATION

This application claims priority under 35 U.S.C. § 119 to Korean Patent Application No. 10-2023-0141894, filed on Oct. 23, 2023, in the Korean Intellectual Property Office, the disclosure of which is incorporated herein by reference in its entirety for all purposes.

### TECHNICAL FIELD

The following disclosure relates to a resistance temperature detector (RTD), and in particular, to an RTD that minimizes damage from thermal stress.

### BACKGROUND

Temperature detectors, which measure temperature by detecting changes in internal resistance, voltage, or current due to temperature changes, include a thermistor using a negative characteristic in which an internal resistance value decreases with temperature, a platinum temperature detector using proportional resistance of a platinum device increasing depending on temperature, and a thermocouple temperature detector using the principle of generating electromotive force when temperature is applied to different objects.

Among them, a platinum temperature detector using platinum devices is used to detect and control high temperatures for industrial purposes, such as electric furnaces, smelting, and blast furnaces, in addition to purposes of measuring engine temperature, transformer insulating oil temperature, gearbox temperature, gas temperature, and operating environment temperature of equipment.

In general, in a platinum temperature detector as shown in FIG. 1 of Korean Application Publication No. 2009-0033131, a meander-shaped platinum resistive film pattern 3 having a platinum contact pad 4 is formed on a sapphire substrate 1, and a protective layer 7 is formed with aluminum oxide (Al₂O₃) to protect the platinum resistive film pattern 3. The protective layer 7 forms a passivation layer 10 formed of glass ceramic for the portion. Terminals 5 are in contact with both ends of the platinum contact pattern 4, lead wires 6a and 6b are connected to the terminals 5, and a protective layer 9 is formed to relieve stress on the lead wires 6a and 6b.

However, in the related art platinum temperature detector, cracks may occur due to thermal shock when bonding the lead wires 6a and 6b and the terminals 5, causing the lead wires 6a and 6b to be separated or disconnected from the electrode, and when used for a long period of time in an environment in which temperatures are 700° C. or higher and vibrations occur, the protective layer 9 formed at a junction of the lead wires 6a and 6b and the terminal 5 falls off due to vibrations or impact.

In addition, an electric wire for measuring resistance according to temperature by applying current to the platinum temperature detector is connected to the lead wires 6a and 6b, and generally, the lead wires 6a and 6b are connected to the electric wire through soldering. However, there is a problem that the lead wires 6a and 6b and the electric wire may also be disconnected due to thermal stress.

In addition, when a flow rate in the temperature detector panel area is high, a pipe may be deformed or broken due to external force, causing a sensor malfunction.

### SUMMARY

An exemplary embodiment of the disclosure is directed to solving the problem of electric wire disconnection caused by thermal stress and minimizing damage caused by a force acting on a ferrule area through design (dual piping and epoxy treatment) of a structure with a strength greater than force applied to the ferrule when a flow rate is high.

In one general aspect, a temperature detector connected to a resistance measurement device and transferring resistance information changed depending on a change in temperature includes: a metal conduit; a temperature detecting device inserted into the metal conduit and including a first lead wire and a second lead wire respectively connected to a plurality of output terminals; and a first wire and a second wire, one side of which is connected to the resistance measurement device and the other side of which is connected to the temperature detecting device, so that the resistance measurement device supplies current to the temperature detecting device, wherein the first wire and the second wire are twisted and connected to the first lead wire and the second lead wire, respectively.

The temperature detector may further include: a third wire connected to the first lead wire, wherein the third wire is connected to the first lead wire in a twisted and bent state with the first wire.

The temperature detector may further include: a fourth wire connected to the second lead wire, wherein the fourth wire is connected to the second lead wire in a twisted and bent state with the second wire.

The temperature detector may further include: epoxy filled between an inner wall of the metal conduit and the temperature detecting device.

The temperature detector may further include: a concentric pipe inserted into the metal conduit; and a ferrule mounted on an outer peripheral surface of the metal conduit, wherein epoxy is applied to the inside of the concentric pipe.

The ferrule may be mounted in a position at which the concentric pipe is inserted to form a double pipe.

The epoxy may be applied to a position at which the ferrule is mounted.

The metal conduit may include an insulator therein, wherein the insulator may be magnesium oxide (MgO).

Other features and aspects will be apparent from the following detailed description, the drawings, and the claims.

### BRIEF DESCRIPTION OF THE DRAWINGS

FIG. 1 is an exploded perspective view of the related art resistance temperature detector.

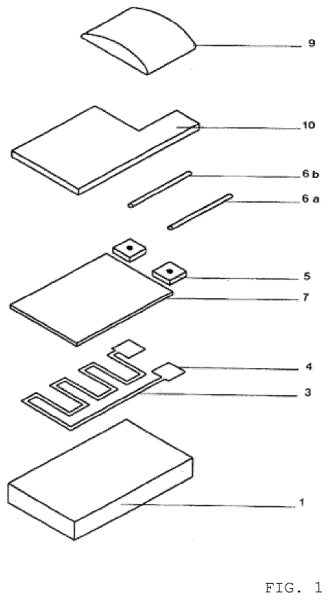

FIG. 2 is a plan view showing a resistance temperature detector according to an exemplary embodiment of the disclosure.

FIG. 3 is a plan view showing a four-wire type resistance temperature detector according to an exemplary embodiment of the disclosure.

### DETAILED DESCRIPTION OF EXEMPLARY EMBODIMENTS

The aspects, features, and advantages of the disclosure will become apparent from the following description of the exemplary embodiments with reference to the accompanying drawings, which are set forth hereinafter. The specific structures and functional description will be only provided for the purpose of illustration of the exemplary embodiments according to the concept of the disclosure, so that the exemplary embodiments of the disclosure may be embodied in many different forms and should not be construed as being limited to the exemplary embodiments set forth herein. The exemplary embodiments according to the concept of the disclosure may be changed to diverse forms, so that the disclosure will be described and illustrated with reference to specific exemplary embodiments. However, it should be understood that the exemplary embodiments according to the concept of the disclosure are not intended to limit to the specific exemplary embodiments disclosed, but they include all the modifications, equivalences, and substitutions, which are included in the scope and spirit of the disclosure. It will be understood that although the terms “first,” “second,” etc. may be used herein to describe various devices, these devices should not be limited by these terms. These terms are only used to distinguish one device from another device. Thus, a first device discussed below could be termed a second device and vice versa without departing from the nature of the disclosure. It will be understood that when a device is referred to as being “connected or coupled” to another device, it may be directly connected or coupled to the other device or intervening devices may be present therebetween. In contrast, when a device is referred to as being “directly connected or coupled” to another device, there are no intervening devices present. Other expressions, such as “between” and “directly between,” or “adjacent” or “directly adjacent” should be understood in a similar manner. The terminology used herein is for the purpose of describing particular exemplary embodiments only and is not intended to limit the disclosure. As used herein, the singular forms “a,” “an” and “the” are intended to include the plural forms as well, unless the context clearly indicates otherwise. It will be further understood that the terms “comprises” and/or “comprising,” or “includes” and/or “including,” when used in this specification, specify the presence of stated features, integers, steps, operations, devices and/or components, but do not preclude the presence or addition of one or more other features, integers, steps, operations, devices, components and/or groups thereof. Unless otherwise defined, the meaning of all terms including technical and scientific terms used herein are the same as those commonly understood by one of ordinary skill in the art to which the disclosure pertains. It will be further understood that terms, such as those defined in commonly used dictionaries, should be interpreted as having a meaning which is consistent with their meaning in the context of the relevant art and the disclosure, and will not be interpreted in an idealized or overly formal sense unless expressly so defined herein. Hereinafter, exemplary embodiments will be described in detail with reference to the accompanying drawings. The same reference numerals indicated in the drawings refer to similar devices throughout.

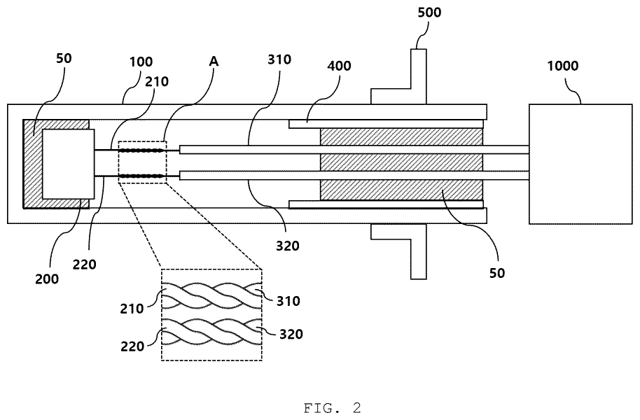

FIG. 2 is a plan view showing a resistance temperature detector according to an exemplary embodiment of the disclosure.

Referring to FIG. 2, a resistance temperature detector according to an exemplary embodiment of the disclosure includes a metal conduit 100, a temperature detecting device 200, a first wire 310, a second wire 320, a concentric pipe 400, a ferrule 500, and epoxy 50. The temperature detecting device 200 includes a first lead wire 210 and a second lead wire 220 and is connected to the resistance measurement device 1000 through the first wire 310 and the second wire 320, respectively, to receive current.

The temperature detecting device 200 is a metal device, such as platinum, nickel, or copper, and may measure temperature using the principle that electrical resistance of a conductor or semiconductor changes with temperature. The temperature detecting device 200 is inserted into the metal conduit 100 and connected to the first wire 310 and the second wire 320 through the first lead wire 210 and the second lead wire 220 respectively connected to a plurality of output terminals to receive current. At this time, the first wire 310 and the second wire 320 may be connected to the first lead wire 210 and the second lead wire 220 in a twisted state, respectively.

One side of the first wire 310 and the second wire 320 may be connected to the resistance measurement device 1000 and the other side may be connected to the temperature detecting device 200 so that current supplied from the resistance measurement device 1000 is supplied to the temperature detecting device 200. The first wire 310 and the second wire 320 may be connected to the first lead wire 210 and the second lead wire 220 of the temperature detecting device 200 in a twisted state A, respectively. As the first wire 310 and the second wire 320 are connected to the first lead wire 210 and the second lead wire 220 in the twisted state A, thermal stress may be generated so that disconnection may not occur even if a tension or compression force is applied to the first wire 310 and the second wire 320.

An empty space between an inner wall of the metal conduit 100 and the temperature detecting device 200 may be filled with epoxy 50 to increase temperature measurement responsiveness and accuracy.

The concentric pipe 400 is a pipe having a smaller diameter than the metal conduit 100 and may be inserted into the metal conduit 100. A ferrule 500 may be mounted on an outer peripheral surface of the metal conduit 100 into which the concentric pipe 400 is inserted. The concentric pipe 400 may increase resistance to pressure applied to the metal conduit 100 as the ferrule 500 is mounted. In addition, epoxy 50 may be applied inside the concentric pipe 400 to retain higher robustness.

The ferrule 500 may be mounted on the outer peripheral surface of the metal conduit 100 and may be mounted in a position at which the concentric pipe 400 is inserted to form a double pipe. In addition, the epoxy 50 filled inside the concentric pipe 400 may be applied to the position at which the ferrule 500 is mounted to improve robustness.

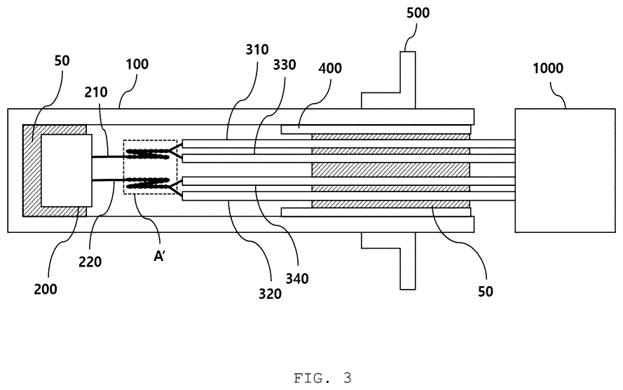

FIG. 3 is a plan view showing a four-wire type resistance temperature detector according to an exemplary embodiment of the disclosure.

Referring to FIG. 3, the resistance temperature detector according to an exemplary embodiment of the disclosure may include a metal conduit 100, a temperature detecting device 200, a first wire 310 and a second wire 320, a third wire 330 and a fourth wire 340, a concentric pipe 400, a ferrule 500, and an epoxy 50. The temperature detecting device 200 includes a first lead wire 210 and a second lead wire 220 and may be connected to a resistance measurement device 1000 through a first wire 310, a third wire 330 and a second wire 320, a fourth wire 340, respectively, to receive current.

The temperature detecting device 200 is a metal device, such as platinum, nickel, or copper, and may measure temperature using the principle that electrical resistance of a conductor or semiconductor changes with temperature. The temperature detecting device 200 may be inserted into the metal conduit 100 and may be connected to the first wire 310 and the third wire 330 and the second wire 320 and the fourth wire 340 respectively through the first lead wire 210 and the second lead wire 220 respectively connected to a plurality of output terminals to receive current.

The first wire 310, the second wire 320, the third wire 330, and the fourth wire 340 have one side connected to the resistance measurement device 1000 and the other side connected to the temperature detecting device 200 so that the current supplied from the resistance measurement device 1000 is supplied to the temperature detecting device 200. The first wire 310 and the third wire 330 may be connected to the first lead wire 210 in a twisted and bent state A′. Here, the first wire 310 and the third wire 330 are connected to the first lead wire 210 by twisting and bending bare copper wire portions, and in this case, the first wire 310 and the third wire 330 may be connected to the first lead wire 210 by a method, such as soldering. In addition, the second wire 320 and the fourth wire 340 may be connected to the second lead wire 220 in the twisted and bent state A′. Here, the second wire 320 and the fourth wire 340 may be connected to the second lead wire 220 by twisting and bending bare copper wire portions, and in this case, the second wire 320 and the fourth wire 340 may be connected to the second lead wire 220 by a method, such as soldering. Since the first wire 310, the third wire 330, the second wire 320, and the fourth wire 340 are connected to the first lead wire 210 and the second lead wire 220 in the twisted and bent state A′, even if thermal stress is generated and tensile or compressive force is applied to the first wire 310, the second wire 320, the third wire 330, and the fourth wire 340, disconnection may not occur.

The empty space between the inner wall of the metal conduit 100 and the temperature detecting device 200 may be filled with the epoxy 50 to increase temperature measurement responsiveness and accuracy.

The concentric pipe 400 is a pipe having a smaller diameter than the metal conduit 100 and may be inserted into the metal conduit 100. A ferrule 500 may be mounted on an outer peripheral surface of the metal conduit 100 into which the concentric pipe 400 is inserted. The concentric pipe 400 may increase resistance to pressure applied to the metal conduit 100 as the ferrule 500 is mounted. In addition, the epoxy 50 may be applied inside the concentric pipe 400, thereby retaining higher robustness.

The ferrule 500 may be mounted on the outer peripheral surface of the metal conduit 100 and may be mounted in a position at which the concentric pipe 400 is inserted to form a double pipe. In addition, the epoxy 50 filled inside the concentric pipe 400 may be applied to the position at which the ferrule 500 is mounted to improve robustness.

According to the present disclosure, disconnection may not occur even if thermal stress occurs and tensile or compressive force is applied to the wire.

In addition, according to the present disclosure, damage caused by the ferrule may be minimized.

In addition, according to the present disclosure, it is possible to obtain an effect of increasing the thickness of the conduit by additionally inserting only the concentric pipe.

In addition, according to the present disclosure, higher robustness may be achieved around the ferrule mounting area by applying epoxy.

In addition, according to the present disclosure, significantly high response speed and accuracy may be retained.

Although the preferred exemplary embodiments of the disclosure have been described above, the exemplary embodiments disclosed in the disclosure are not intended to limit the technical spirit of the disclosure, but are only for explanation. Therefore, the technical spirit of the disclosure includes not only each disclosed exemplary embodiment, but also a combination of the disclosed exemplary embodiments, and furthermore, the scope of the technical spirit of the disclosure is not limited by these exemplary embodiments. In addition, those skilled in the art to which the disclosure pertains may make many changes and modifications to the disclosure without departing from the spirit and scope of the appended claims, and all such appropriate changes and modifications, as equivalents, are to be regarded as falling within the scope of the disclosure.

### DETAILED DESCRIPTION OF MAIN DEVICES

50: epoxy
100: metal conduit
200: temperature detecting device
210: first lead wire
220: second lead wire
310: first wire
320: second wire
330: third wire
340: fourth wire
400: concentric piping
500: ferrule
1000: resistance measurement device

What is claimed is:

1. A temperature detector connected to a resistance measurement device and transferring resistance information changed depending on a change in temperature, the temperature detector comprising:
a metal conduit;
a temperature detecting device inserted into the metal conduit and including a first lead wire and a second lead wire respectively connected to a plurality of output terminals; and
a first wire and a second wire, one side of which is connected to the resistance measurement device and the other side of which is connected to the temperature detecting device, so that the resistance measurement device supplies current to the temperature detecting device,
wherein the first wire and the second wire are twisted and connected to the first lead wire and the second lead wire, respectively.

2. The temperature detector of claim 1, further comprising:
a third wire connected to the first lead wire,
wherein the third wire is connected to the first lead wire in a twisted and bent state with the first wire.

3. The temperature detector of claim 1, further comprising:
a fourth wire connected to the second lead wire,
wherein the fourth wire is connected to the second lead wire in a twisted and bent state with the second wire.

4. The temperature detector of claim 1, further comprising:
epoxy filling a space between an inner wall of the metal conduit and the temperature detecting device.

5. The temperature detector of claim 1, further comprising:
a concentric pipe inserted into the metal conduit; and
a ferrule mounted on an outer peripheral surface of the metal conduit,
wherein epoxy is applied to the inside of the concentric pipe.

6. The temperature detector of claim 5, wherein the ferrule is mounted in a position at which the concentric pipe is inserted to form a double pipe.

7. The temperature detector of claim 5, wherein the epoxy is applied to a position at which the ferrule is mounted.

8. The temperature detector of claim 1, wherein the metal conduit includes an insulator therein, wherein the insulator is magnesium oxide (MgO).
